(19) United States
(12) Patent Application Publication
(10) Pub. No.: US 2005/0100029 A1
(43) Pub. Date: May 12, 2005

(54) Ad hoc network routing for hotspot mitigation and load balancing in wireless LANs

(75) Inventor: Samir R. Das, Melville, NY (US)

Correspondence Address: F. CHAU & ASSOCIATES, LLC, 130 WOODBURY ROAD, WOODBURY, NY, 11797, US

(73) Assignee: Research Foundation of the State University of New York

(21) Appl. No.: 10/988,480

(22) Filed: Nov. 12, 2004

Related U.S. Application Data
(60) Provisional application No. 60/519,205, filed on Nov. 12, 2003.

(51) Int. Cl. H04L 12/56

(52) U.S. Cl. 370/401

(57) ABSTRACT

A method for balancing network load among mobile hosts includes determining and monitoring a performance of a first access point connected to a mobile host by an infrastructure network, determining that the performance of the first access point is undesirable, and virtualizing a network interface of the mobile host connected to the first access point, wherein an ad hoc network are established in addition to the infrastructure network. The method further including determining a route to a second access point through at least one cooperating mobile host, and switching a connection of the mobile host to the second access point via the route to the second access point, wherein the connection is established via the ad hoc network.

This application claims priority to U.S. Provisional Application No. 60/519,205, filed on Nov. 12, 2003, entitled “Ad Hoc Network Routing for Hotspot Mitigation and Load Balancing in Wireless LANS,” the disclosure of which is herein incorporated by reference in its entirety.

### BACKGROUND OF THE INVENTION

1. Field of the Invention

The present invention relates to network routing, and more particularly to a system and method for network routing for hotspot mitigation and load balancing in wireless local area networks.

2. Discussion of Related Art

The proliferation of Wi-Fi or IEEE 802.11 based wireless local area networks (WLAN) presents new technological problems. Among them is the notion of “hotspots”—highly populated regions of nomadic users accessing a WLAN simultaneously. Public places with WLAN service, such as conference venues and coffee shops, are an example of a hotspot. High network load in a hotspot may saturate the cell of the wireless access point (AP) that covers a network region and cause performance degradation. One proposed solution for this problem has been over-provisioning the WLAN deployment. This is achieved by provisioning additional APs, with nearby APs operating on different channels, and then providing some inter-AP load balancing. This proposed solution, however, not only needs over-provisioning, but also needs a high-degree of coordination among APs. This, in turn, leads to the need for custom, hardware-based solutions on the APs. Since no standard exists, the APs need to come from the same vendor who provides such custom solutions. The custom solution may not be applicable in all cases—for example, in situations where the mobile client is reachable only from a set of APs that are all highly loaded.

Therefore, a need exists for alternative, client-side methods for hotspot mitigation and load balancing independent of the design of the APs.

### SUMMARY OF THE INVENTION

According to an embodiment of the present disclosure, a method for balancing network load among mobile hosts includes determining and monitoring a performance of a first access point connected to a mobile host by an infrastructure network, determining that the performance of the first access point is undesirable, and virtualizing a network interface of the mobile host connected to the first access point, wherein an ad hoc network are established in addition to the infrastructure network. The method further including determining a route to a second access point through at least one cooperating mobile host, and switching a connection of the mobile host to the second access point via the route to the second access point, wherein the connection is established via the ad hoc network.

The method includes monitoring the performance of the second access point during the connection of the mobile host to the second access point. The method includes switching to the first access point on the infrastructure network upon determining the performance of the second access point to be undesirable.

The performance is measured by data throughput. The performance is measured by determining dropped associations to the first access point.

The method comprises switching from the second access point to the first access point upon determining a breakage of the route to the second access point.

The method comprises determining that the performance of the first access point upon determining a breakage of the route, switching from the second access point to the first access point upon determining the performance to be desirable, and determining a route to a third access point upon determining the performance to be undesirable.

The method further comprises relaying data from a current access point to the mobile host through the at least one cooperating mobile host.

According to an embodiment of the present disclosure, a program storage device is provided readable by machine, tangibly embodying a program of instructions executable by the machine to perform method steps for balancing network load among mobile hosts. The method comprises determining and monitoring a performance of a first access point connected to a mobile host by an infrastructure network, determining that the performance of the first access point is undesirable, and virtualizing a network interface of the mobile host connected to the first access point, wherein an ad hoc network are established in addition to the infrastructure network. The method includes determining a route to a second access point through at least one cooperating mobile host, and switching a connection of the mobile host to the second access point via the route to the second access point, wherein the connection is established via the ad hoc network.

According to an embodiment of the present disclosure, a method for balancing network load among mobile hosts includes determining and monitoring a performance of a first access point connected to a mobile host by an infrastructure network, determining that the performance of the first access point is undesirable, and establishing a connection to an ad hoc network of at least one cooperating mobile host. The method includes determining a route to a second access point through the at least one cooperating mobile host, and switching a connection of the mobile host to the second access point via the route to the second access point, wherein the connection is established via the ad hoc network, the ad hoc network relaying data between the second access point and the mobile host.

### BREIF DESCRIPTION OF THE DRAWINGS

Preferred embodiments of the present invention will be described below in more detail, with reference to the accompanying drawings:

FIG. 1 is an illustration of a network according to an embodiment of the present disclosure;

FIG. 2 is an illustration of a system according to an embodiment of the present disclosure; and

FIG. 3 is a flow chart of a method according to an embodiment of the present disclosure.

### DETAILED DESCRIPTION OF PREFERRED EMBODIMENTS

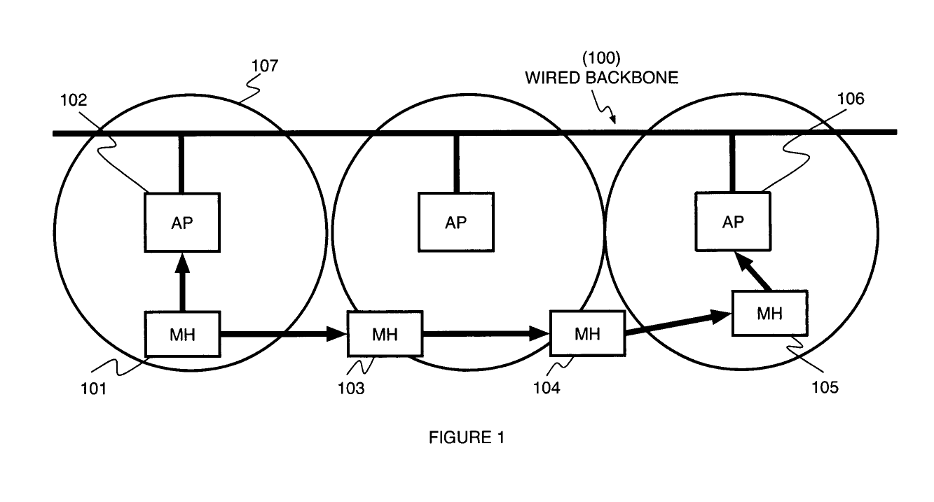

According to an embodiment of the present disclosure, hot-spot mitigation may be implemented as a pure software solution that can be deployed on a group of cooperating mobile end hosts. The group of cooperating mobile hosts form an “ad hoc” network among themselves. They cooperate to relieve the congestion experienced by one or more hosts in a hotspot, by relaying their data—via a different channel—through intermediate hosts to a remote AP that is not congested, including for example, a wireless router platform (see FIG. 1). No over-provisioning or custom solution on the AP is needed. It is useful and deployable whenever a group of cooperating hosts exist in the network, for example, in large meetings or conferences a group of coworkers from an organization relay each other's packets for better overall performance.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

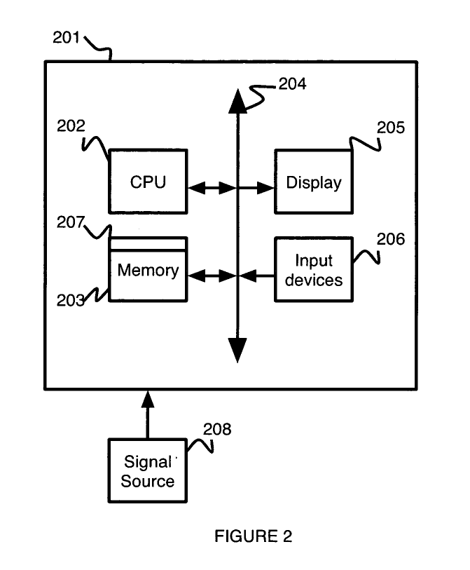

Referring to FIG. 2, according to an embodiment of the present invention, a computer system 201 for implementing the present invention can comprise, inter alia, a central processing unit (CPU) 202, a memory 203 and an input/output (I/O) interface 204. The computer system 201 is generally coupled through the I/O interface 204 to a display 205 and various input devices 206 such as a mouse and keyboard. The support circuits can include circuits such as cache, power supplies, clock circuits, and a communications bus. The memory 203 can include random access memory (RAM), read only memory (ROM), disk drive, tape drive, etc., or a combination thereof. The present invention can be implemented as a routine 207 that is stored in memory 203 and executed by the CPU 202 to process the signal from the signal source 208. As such, the computer system 201 is a general purpose computer system that becomes a specific purpose computer system when executing the routine 207 of the present invention.

The computer platform 201 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Referring to FIG. 1; a plurality of APs are connected through a wired backbone 100 to form a hotspot. Mobile host (MH) 101 finds AP 102 to be congested. Congestion may be determined, for example, via a measure of throughput in KB/Sec or MB/Sec. Congestion can be also determined by dropped associations from AP 102. MH 101 routes its connection on a different channel through the ad hoc network formed with the intermediate mobile hosts 103-105 to another AP 106. In this example, AP 106 and MHs 103-105 are already operating on a different channel. The last mobile host in this new route, e.g., MH 105, needs to have two network interfaces, or one interface that switches between two modes to connect to two networks. This is explained in the following paragraph. The communication ranges of the APs are indicated by circles (e.g., 107).

A network interface of a MH connects to an AP in a mode called “infrastructure mode,” but it connects to other MHs in a different mode, called the “ad hoc mode.” Since both the first and the last MH of the route (e.g., MH 101 and MH 105) need to talk to both an AP (106) and a MH (105), they need to have at least two interfaces. If two interfaces are not available, the MHs can switch periodically between the two modes by implementing two “virtual” interfaces on one available physical interface. Periodic switching can happen, for example, every 100 milli-seconds or every 10,000 packets received, between the two modes. When the interface is in the ad hoc mode, the packets for the infrastructure mode are buffered. When the interface is in the infrastructure mode mode, the packets for the ad hoc mode are buffered. The buffer may be implemented in hardware and/or software on the MH.

An on-demand routing technique such as Ad Hoc On-Demand Distance Vector Routing (AODV) may be used in a modified form to discover routes to remote APs or any wireless router (that is connected to wired networks) that is not congested. According to AODV, routes are created between MHs upon determining a request of an MH. Thus, MHs may freely enter and leave the network. Routes remain active as long as data travels between end points on the paths. Paths may time out and close upon determining that data is not being passed. One of ordinary skill in the art would recognize that other routing techniques may be used, such as signal stability based adaptive routing (SSA) ar any other mobile ad hoc network (MANET) routing protocol.

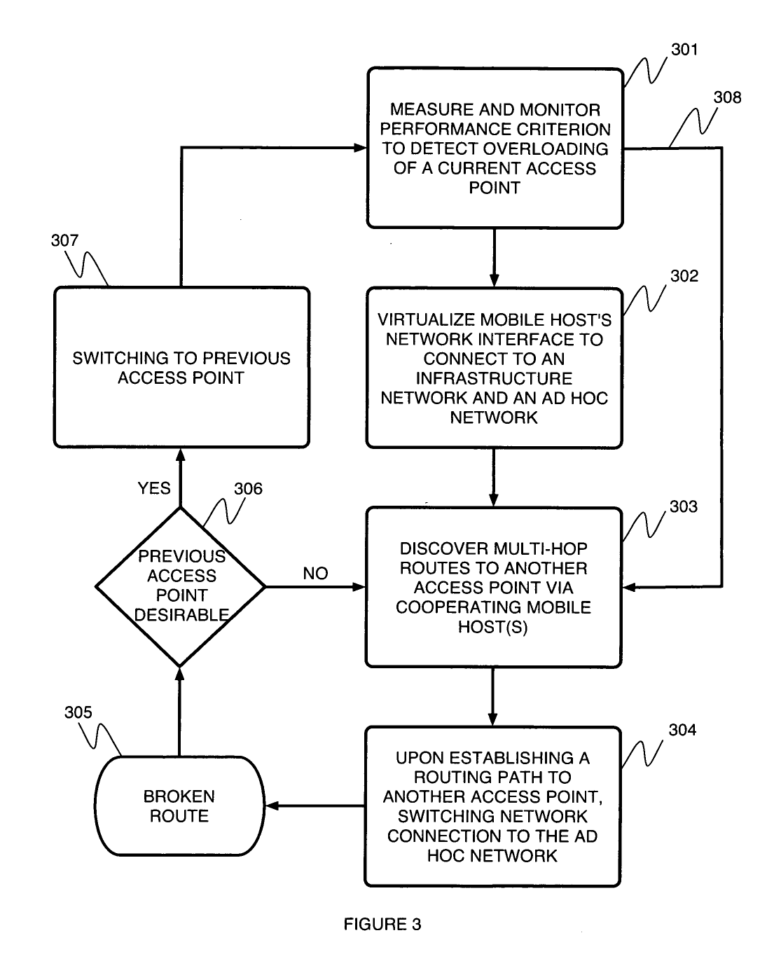

Referring to FIG. 3, the performance criterion on the mobile host, such as throughput, is measured and monitored to detect overloading problems in the current cell of the AP it is currently associated with (301). The mobile host's wireless network interface is virtualized by software to connect to both an infrastructure network and an ad hoc network simultaneously and to switch between two networks periodically (302). This provides a seamless connectivity to both networks even with a single network interface. The ad hoc network is used to discover multi-hop routes to another AP (303) having a desirable load. The desirable load may be a load less than the current AP or some absolute value of a performance criterion. While the route discovery is in progress, the connectivity is maintained to the original AP so that data communication is not interrupted. Once the routing path is established, data communication is switched to the ad hoc network 304. In the case of a breakage of the routing path 305, for example, because of host mobility, communication is returned to the original AP 307. If the load on the original AP is not still desirable 306, a new route discovery can be made 303.

The virtualization technique makes it possible to use the same network interface as two different network interfaces that are operated in different modes. This can be implemented in software by exporting two different interfaces to the upper layer software (for example, routing) for the same physical device. Both these virtual interfaces connect to the same device driver. The device driver changes the mode of the device to deliver packets at different modes. While one mode is used, the packets for the other mode are buffered.

A mobile host may be, for example, laptop computer, a personal digital assistance or other client device capable of wireless network connectivity. The mobile host may be equipped with multiple wireless interfaces. In the case of multiple wireless interfaces, the virtualization technique may not be needed where the number of network connections is less than or equal to the number of wireless interfaces (308). According to FIG. 1, in that case the MH 105 can maintain the two network interfaces in ad hoc and infrastructure modes—communicating with its peers in ad hoc mode and maintaining connectivity with the AP in infrastructure mode. The routing protocol deployed (such as AODV) can put more preference for using dual interface mobile hosts as the gateway to the AP for performance purposes.

Having described embodiments for a system and method for network routing for hotspot mitigation and load balancing, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method for balancing network load among mobile hosts comprising:
determining and monitoring a performance of a first access point connected to a mobile host by an infrastructure network;
determining that the performance of the first access point is undesirable;
virtualizing a network interface of the mobile host connected to the first access point, wherein an ad hoc network are established in addition to the infrastructure network;
determining a route to a second access point through at least one cooperating mobile host; and
switching a connection of the mobile host to the second access point via the route to the second access point, wherein the connection is established via the ad hoc network.

2. The method of claim 1, further comprising monitoring the performance of the second access point during the connection of the mobile host to the second access point.

3. The method of claim 2, further comprising switching to the first access point on the infrastructure network upon determining the performance of the second access point to be undesirable.

4. The method of claim 1, wherein the performance is measured by data throughput.

5. The method of claim 1, wherein the performance is measured by determining dropped associations to the first access point.

6. The method of claim 1, further comprising switching from the second access point to the first access point upon determining a breakage of the route to the second access point.

7. The method of claim 1, further comprising:
determining that the performance of the first access point upon determining a breakage of the route;
switching from the second access point to the first access point upon determining the performance to be desirable; and
determining a route to a third access point upon determining the performance to be undesirable.

8. The method of claim 1, further comprising relaying data from a current access point to the mobile host through the at least one cooperating mobile host.

9. A program storage device readable by machine, tangibly embodying a program of instructions executable by the machine to perform method steps for balancing network load among mobile hosts, the method steps comprising:
determining and monitoring a performance of a first access point connected to a mobile host by an infrastructure network;
determining that the performance of the first access point is undesirable;
virtualizing a network interface of the mobile host connected to the first access point, wherein an ad hoc network are established in addition to the infrastructure network;
determining a route to a second access point through at least one cooperating mobile host; and
switching a connection of the mobile host to the second access point via the route to the second access point, wherein the connection is established via the ad hoc network.

10. The method of claim 9, further comprising monitoring the performance of the second access point during the connection of the mobile host to the second access point.

11. The method of claim 10, further comprising switching to the first access point on the infrastructure network upon determining the performance of the second access point to be undesirable.

12. The method of claim 9, wherein the performance is measured by data throughput.

13. The method of claim 9, wherein the performance is measured by determining dropped associations to the first access point.

14. The method of claim 9, further comprising switching from the second access point to the first access point upon determining a breakage of the route to the second access point.

15. The method of claim 9, further comprising:
determining that the performance of the first access point upon determining a breakage of the route;
switching from the second access point to the first access point upon determining the performance to be desirable; and
determining a route to a third access point upon determining the performance to be undesirable.

16. The method of claim 9, further comprising relaying data from a current access point to the mobile host through the at least one cooperating mobile host.

17. A method for balancing network load among mobile hosts comprising:
determining and monitoring a performance of a first access point connected to a mobile host by an infrastructure network;
determining that the performance of the first access point is undesirable;
establishing a connection to an ad hoc network of at least one cooperating mobile host;
determining a route to a second access point through the at least one cooperating mobile host; and
switching a connection of the mobile host to the second access point via the route to the second access point, wherein the connection is established via the ad hoc network, the ad hoc network relaying data between the second access point and the mobile host.
